(19) United States
(12) Patent Application Publication
(10) Pub. No.: US 2023/0092192 A1
(43) Pub. Date: Mar. 23, 2023

(54) DAMPING BRACKET FOR SUPPORTING ARTICLES AND PROTECTIVE CASE FOR ELECRONIC DEVICE WITH SAME

(71) Applicant: Shenzhen City Kaixin International Trade Co., Ltd, Shenzhen (CN)

(72) Inventor: Kui JIA, Shenzhen (CN)

(21) Appl. No.: 17/578,608

(22) Filed: Jan. 19, 2022

(30) Foreign Application Priority Data
Sep. 18, 2021 (CN) 2021222743115

(51) Int. Cl. H04B 1/3877; A45C 11/00

(52) U.S. Cl. CPC H04B 1/3877; A45C 11/00; A45C 2011/002; A45C 2200/15

(57) ABSTRACT

A damping bracket and protective case for an electronic device with the same is disclosed, the damping bracket includes a base, a supporting part and a damping shaft; the damping shaft is a tubular member capable of elastic deformation in a radial direction, and an opening penetrating through both ends of the damping shaft is provided; one end of the base is provided with a first connecting part, and the first connecting part is provided with a first shaft hole; the supporting part is provided with a hinge end and a supporting end, the supporting end is provided with a second connecting part, and the connecting second part is provided with a second shaft hole; the damping shaft is arranged in the first shaft hole and the second shaft hole in an interference fit manner; the damping bracket is installed on the back side of the mobile phone case, which can provide multi-angle support for the horizontal screen and vertical screen of the mobile phone, free both hands, and ensure the clear picture of the mobile phone by adjusting the angle to adapt to different light angles.

### TECHNICAL FIELD

The present disclosure relates to the technical field of brackets, and more specifically, to a damping bracket for supporting articles and an protective case for an electronic device with the damping bracket.

### BACKGROUND ART

At present, many articles for placing decoration and hand-held articles need to be conveniently placed and stored, so as to free both hands for independent placement, and more convenient and fast when storage is required, such as photo frames, mobile phones, etc, and this problem can be solved by providing a support frame on the back side of the photo frame and the back side of the collection case.

However, the conventional support frame is generally exposed on the back side of the article, and the support angle is fixed, is inconvenient to store, and cannot adjust the support angle according to factors such as illumination, thereby affecting viewing and inconvenience.

Therefore, how to provide a damping bracket capable of freely adjusting the support angle is an urgent problem to be solved by those skilled in the art.

### SUMMARY

In view of the above, the present disclosure aims to provide a damping bracket to at least solve one of the above technical problems in the prior art to a certain extent.

In order to achieve the above purpose, the disclosure adopts the following technical scheme:

a damping bracket includes a base, a supporting part and a damping shaft;

wherein the damping shaft is a tubular member capable of elastic deformation in a radial direction, and an opening penetrating through both ends of the damping shaft is provided;

one end of the base is provided with a first connecting part, and the first connecting part is provided with a first shaft hole; the supporting part is provided with a hinge end and a supporting end, the supporting end is provided with a second connecting part, and the connecting second part is provided with a second shaft hole; the damping shaft is arranged in the first shaft hole and the second shaft hole in an interference fit manner.

According to the above technical scheme, compared with the prior art, the disclosure discloses a damping bracket, which has the advantages that:

a damping shaft capable of radial deformation is provided, after the damping shaft is inserted into the first shaft hole and the second shaft hole, due to elastic deformation, an external force is applied to the inner walls of the first shaft hole and the second shaft hole to form an interference fit with the supporting part and the base, in addition, the supporting part can rotate by taking the damping shaft as an axis, and can hover at any angle to realize multi-angle adjustment.

Preferably, in the above damping bracket, the first connecting part is provided with two sections side by side, and there is a gap in the middle;

the second connecting part is arranged between two sections of the first connecting part, and the damping shaft penetrates through the first connecting part and the second connecting part in turn.

Preferably, in the above damping bracket, the damping shaft is a tubular member formed by crimping an elastic material, and an opening is formed at the mating edge.

Preferably, in the above damping bracket, the damping shaft is a cylindrical structure formed by rolling an elastic materials, and the butt edges of the damping shaft are tooth-shaped edges corresponding to each other.

Both sides of the supporting end of the supporting part are provided with a card slot.

Preferably, in the above damping bracket, the supporting part is plate-shaped, and a supporting surface of the supporting end of the supporting part is an inclined surface.

A protection case for an electronic device includes a housing and a damping bracket; the damping bracket is arranged on the back side of the housing, and the damping bracket is the damping bracket described above.

Preferably, in the above protection case for an equipment device, the back side of the housing is provided with a first embedding groove corresponding to the supporting part, the first embedding groove is provided with a second embedding groove at the position corresponding to the base, the side wall of the second embedding groove is provided with a limiting groove for clamping the base, and the first embedding groove is internally provided with a limiting protrusion for clamping the supporting part; the base may be a substrate.

The side wall of the base is provided with a clamping protrusion, the base is embedded in the second embedding groove, and the clamping protrusion is clamped into the limiting groove;

both sides of the supporting end of the supporting part are provided with a card slot, and the card slot is detachably connected with the limiting protrusion.

Preferably, the housing is a double-layer structure, and comprises a core layer and an outer layer which are attached and fixed; the outer layer is provided with a first embedding groove corresponding to the supporting part, the core layer is integrally formed with the second embedding groove, the limiting groove and the limiting protrusion at the position corresponding to the first embedding groove.

Preferably, in the protection case for an electronic device, when the supporting part is embedded in the first embedding groove, the outer wall side of the supporting part is flush with the outer surface of the outer layer.

According to the above technical scheme, compared with the prior art, the present disclosure provides a protection case for an electronic device, wherein the damping bracket is installed on the back side of the mobile phone case, which can provide multi-angle support for the horizontal screen and vertical screen of the mobile phone, free both hands, and ensure the clear picture of the mobile phone by adjusting the angle to adapt to different light angles.

### BRIEF DESCRIPTION OF THE DRAWINGS

In order to more clearly explain the embodiment of the disclosure or the technical scheme in the prior art, the following will briefly introduce the drawings needed in the description of the embodiment or the prior art, obviously, the drawings in the following description are only the embodiment of the disclosure, and for ordinary technicians in the field, other drawings can be obtained according to the provided drawings without paying creative efforts.

FIG. 1 is a structural schematic diagram of the damping bracket in the supporting state provided by the present disclosure;

FIG. 2 is a structural schematic diagram of the damping bracket in the buckled state provided by the present disclosure;

FIG. 3 is an exploded schematic diagram of the damping bracket provided by the present disclosure;

FIG. 4 and FIG. 5 are schematic diagram of the housing in the supporting state provided by the present disclosure;

FIG. 6 is an exploded schematic diagram of the housing provided by the present disclosure;

FIG. 7 is a partial enlarged view of the core layer provided by the present disclosure;

FIG. 8 is a schematic view of the installation of the base and the core layer provided by the present disclosure;

FIG. 9 a schematic diagram of the installation of the damping bracket and the housing provided by the present disclosure.

FIG. 10 is a schematic diagram of the damping bracket being buckled in the housing provided by the present disclosure.

### DETAILED DESCRIPTION OF THE EMBODIMENTS

The following will clearly and completely describe the technical scheme in the embodiment of the disclosure with reference to the drawings in the embodiment of the disclosure, obviously, the described embodiment is only a part of the embodiment of the disclosure, not all the embodiments. Based on the examples in this disclosure, all other examples obtained by ordinary technicians in this field without creative work are within the scope of protection of this disclosure.

In the description of the present disclosure, it should be understood that, terms “up,” “down,” “front,” “back,” “left,” “right,” “vertical,” “horizontal,” “top,” “bottom” and “inside,” the orientation or position relationship of the indication of “external” or the like is based on the orientation or position relationship shown in the drawings, and is only for convenience of description and simplification of description of the present disclosure, rather than indicating or implying that the device or element referred to must have a particular orientation, be constructed and operated in a particular orientation, and therefore cannot be construed as a limitation of the present disclosure.

In the present disclosure, the terms “installed,” “connected,” “connected,” “fixed” and the like are to be understood in a broad sense, for example, fixed connection, in addition, it may be a detachable connection, or it may be a unitary connection, it may be a mechanical connection, it may be an electrical connection; can be directly connected or indirectly connected through an intermediate medium, it may be a connection within two elements or an interaction relationship between the two elements. For those skilled in the art, the specific meanings of the above terms in the present disclosure can be understood according to specific conditions.

### Embodiment 1

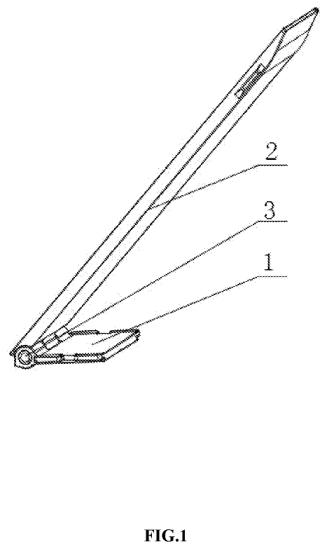

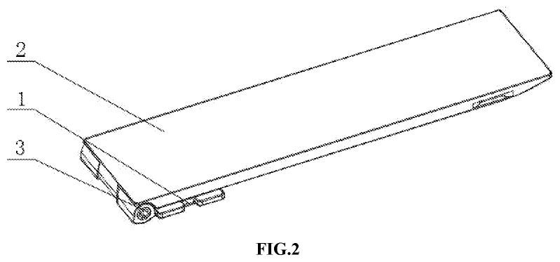

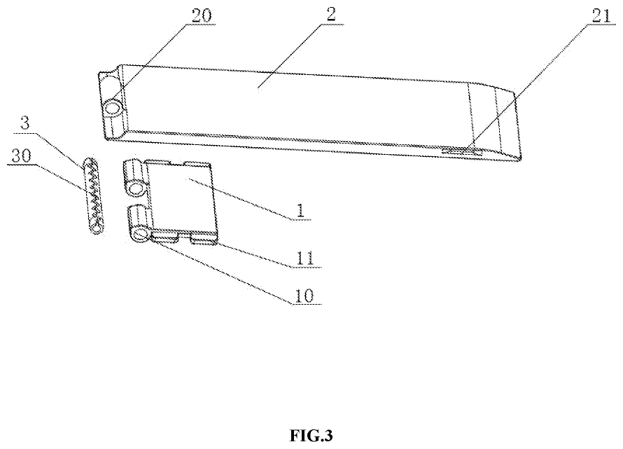

Referring to FIGS. 1-3, a damping bracket according to the present disclosure includes a base 1, a supporting part 2 and a damping shaft 3, wherein the damping shaft 3 is a tubular member capable of elastic deformation in a radial direction, and an opening 30 penetrating through both ends of the damping shaft is provided;

one end of the base 1 is provided with a first connecting part 10, and the first connecting part 10 is provided with a first shaft hole; the supporting part 2 is provided with a hinge end and a supporting end, the supporting end is provided with a second connecting part 20, and the connecting second part is provided with a second shaft hole; the damping shaft 3 is arranged in the first shaft hole and the second shaft hole in an interference fit manner.

In order to further optimize the above technical scheme, the damping shaft 3 can be a tubular member formed by rolling elastic material, and the tubular member can form an opening 30 at the butting edge.

Specifically, the elastic material can be steel sheet or plastic sheet.

In order to further optimize the above technical scheme, the first connecting part 10 is provided with two sections side by side, and there is a gap in the middle;

the second connecting part 20 is arranged between two sections of the first connecting part 10, and the damping shaft 3 penetrates through the first connecting part 10 and the second connecting part 20 in turn.

By adopting this scheme, the stability of the supporting part in the rotating process can be ensured, and the service life can be ensured.

Specifically, the position of the second supporting part corresponding to the outer side of the second connecting part 20 can be provided with a limiting plate, and the inner side of the limiting plate is an inclined surface corresponding to the first connecting part 10, by adopting this scheme, the opening and closing angle of the supporting part 2 can be limited to ensure that the opening and closing angle is between 0 and 85 degrees.

By adopting this scheme, after the damping shaft 3 penetrates into the first shaft hole and the second shaft hole, the damping shaft 3 is affected by elastic deformation, the shaft diameter expands, and an interference fit is formed with the inner walls of the first shaft hole and the second shaft hole, which ensures that the supporting part can stop at any angle and achieves the damping effect.

In order to further optimize that technical scheme, the butting edge of the opening 30 can be tooth-shaped edges corresponding to each other, and the opening 30 can be ensure to extend into the first shaft hole and the second shaft hole during the pressing process, after releasing the pressure, it can be interference fit with the first shaft hole and the second shaft hole to realize any angle adjustment, and the opening and the teeth can also provide the friction force of the damping shaft 3 in the first connecting part 10 and the second connecting part 20.

### Embodiment 2

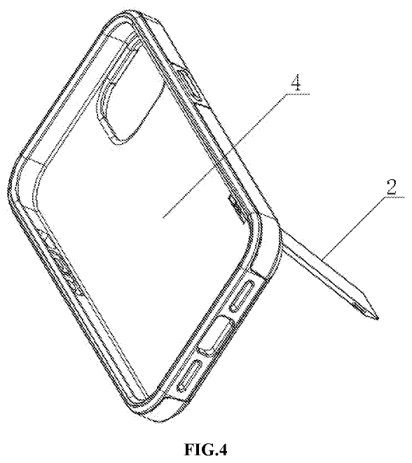

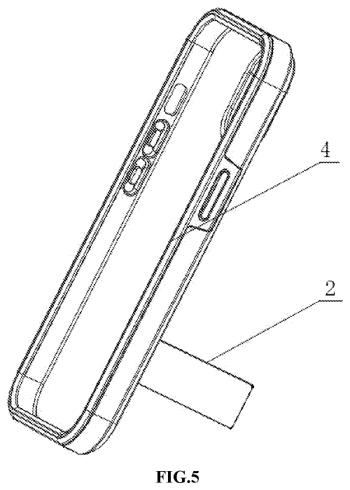

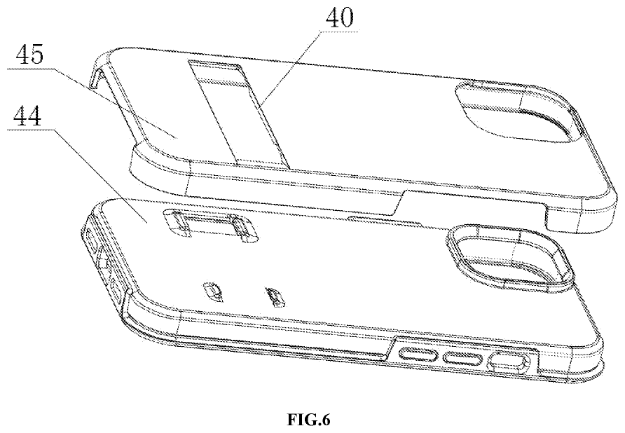

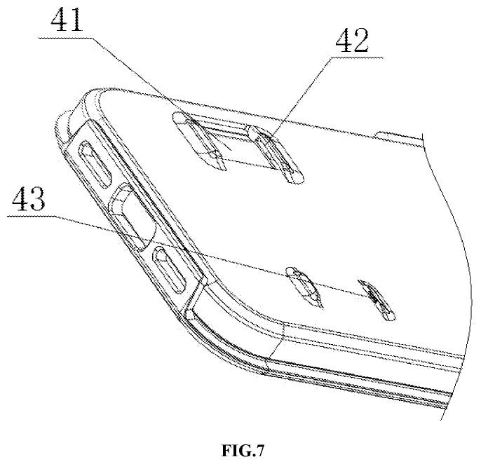

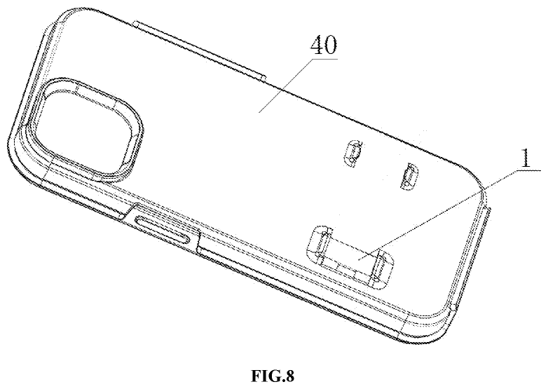

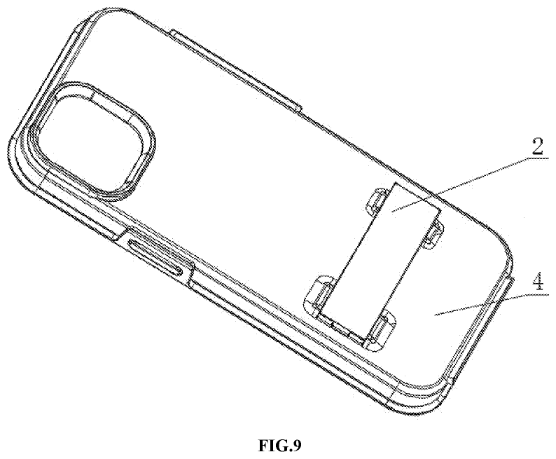

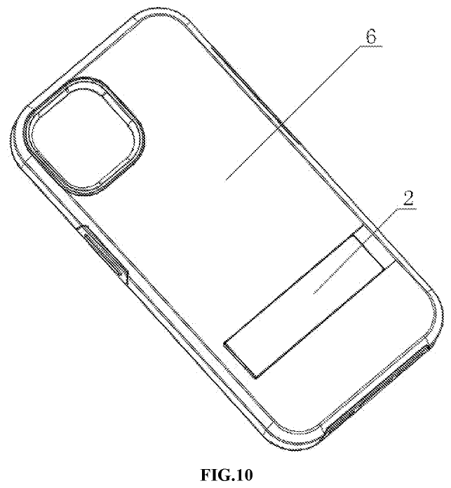

Referring to FIGS. 4-10, a protective case for an electronic device according to the present disclosure includes a housing 4 and a damping bracket, the damping bracket is arranged on the back side of the housing 4, and the damping bracket is the damping bracket in embodiment 1, and the electronic device may include electronic devices such as a mobile phone case, a tablet or a tablet computer.

In order to further optimize the above technical scheme, the back side of the housing 4 is provided with a first embedding groove 40 corresponding to the supporting part 2, the first embedding groove 40 is provided with a second embedding groove 41 at the position corresponding to the base 1, the side wall of the second embedding groove 41 is provided with a limiting groove 42 for clamping the base 1, and the first embedding groove is internally provided with a limiting protrusion 43 for clamping the supporting part 2;

the side wall of the base 1 is provided with a clamping protrusion 11, the base 1 is embedded in the second embedding groove 41, and the clamping protrusion 11 is clamped into the limiting groove 42;

both sides of the supporting end of the supporting part 2 are provided with a card slot 21, and the card slot is detachably connected with the limiting protrusion 43.

In order to further optimize the above technical scheme, the housing 4 is a double-layer structure including a core layer 44 and an outer layer 45 which are attached and fixed; the outer layer 45 is provided with a first embedding groove 40 corresponding to the supporting part 2, the core layer 44 is integrally formed with the second embedding groove 41, the limiting groove 42 and the limiting protrusion 43 at the position corresponding to the first embedding groove 40.

In order to further optimize the above technical scheme, when the supporting part 2 is embedded in the first embedding groove 40, the outer wall side of the supporting part 2 is flush with the outer surface of the outer layer 45.

Specifically, the protective case for an electronic device can be made of elastic material, during installation, the housing 4 is bent along the longitudinal direction of the first embedding groove 40 and the second embedding groove 41, so that the housing 4 is elastically deformed, then, the base 1 of the assembled damping bracket is champed into the second embedding groove 41, the external force is removed, and the housing 4 is restored, and the clamping protrusion 11 of the base 1 is engaged with the limiting groove 42 to complete the installation.

In this specification, each embodiment is described in a progressive way, and each embodiment focuses on the differences from other embodiments, so it is enough to refer to the same and similar parts between each embodiment. For the device disclosed in the embodiment, since it corresponds to the method disclosed in the embodiment, the description is relatively simple, and for the relevant points, refer to the description of the method part.

The above description of the disclosed embodiments enables those skilled in the art to realize or use the present disclosure. Various modifications to these embodiments will be obvious to those skilled in the art, and the general principles defined herein can be implemented in other embodiments without departing from the spirit or scope of the disclosure. Accordingly, the present disclosure will not be limited to the embodiments shown herein, but will be accorded the widest scope consistent with the principles and novel features disclosed herein.

What is claimed is:

1. A damping bracket, comprising: a base (1), a supporting part (2) and a damping shaft (3);
wherein the damping shaft (3) is a tubular member capable of elastic deformation in a radial direction, and an opening (30) penetrating through both ends of the damping shaft is provided;
one end of the base (1) is provided with a first connecting part (10), and the first connecting part (10) is provided with a first shaft hole;
the supporting part (2) is provided with a hinge end and a supporting end, the supporting end is provided with a second connecting part (20), and the connecting second part is provided with a second shaft hole;
the damping shaft (3) is arranged in the first shaft hole and the second shaft hole in an interference fit manner.

2. The damping bracket of claim 1, wherein the damping shaft (3) is a cylindrical structure formed by rolling an elastic material.

3. The damping bracket of claim 2, wherein the elastic material is a steel sheet or a plastic sheet.

4. The damping bracket of claim 3, wherein the abutting edges of the opening (30) are tooth-shaped edges corresponding to each other.

5. The damping bracket of claim 4, wherein the supporting part is plate-shaped, and a supporting surface of the supporting end of the supporting part is an inclined surface.

6. A protection case for an electronic device, comprising a housing (4), wherein the housing (4) further comprises the damping bracket of claim 1; the damping bracket is arranged on the back side of the housing (4).

7. The protection case of claim 6, wherein the housing (4) is made of an elastic material, and the back side of the housing is provided with a first embedding groove (40) corresponding to the supporting part (2), the first embedding groove (40) is provided with a second embedding groove (41) at the position corresponding to the base (1), the side wall of the second embedding groove (41) is provided with a limiting groove (42) for clamping the base (1), and the first embedding groove is internally provided with a limiting protrusion (43) for clamping the supporting part (2);
the side wall of the base (1) is provided with a clamping protrusion (11), the base (1) is embedded in the second embedding groove (41), and the clamping protrusion (11) is clamped into the limiting groove (42);
both sides of the supporting end of the supporting part (2) are provided with a card slot (21), and the card slot is detachably connected with the limiting protrusion (43).

8. The protection case of claim 7, wherein the housing (4) is a double-layer structure, and comprises a core layer (44) and an outer layer (45) which are attached and fixed;
the outer layer (45) is provided with a first embedding groove (40) corresponding to the supporting part (2), the core layer (44) is integrally formed with the second embedding groove (41), the limiting groove (42) and the limiting protrusion (43) at the position corresponding to the first embedding groove (40).

9. The protection case of claim 8, wherein the outer wall side of the supporting part (2) is flush with the outer surface of the outer layer (45) when the supporting part (2) is embedded in the first embedding groove (40).
